(19) United States
(12) Patent Application Publication
(10) Pub. No.: US 2016/0282960 A1
(43) Pub. Date: Sep. 29, 2016

(54) MOVABLE DEVICE

(71) Applicants: PIONEER CORPORATION, Kawasaki-shi, Kanagawa (JP); TOHOKU PIONEER CORPORATION, Tendo-shi, Yamagata (JP)

(72) Inventors: Makoto ABE, Yamagata (JP); Takeru MIKI, Yamagata (JP); Masanori SHOJI, Yamagata (JP); Kenji KAWAMURA, Yamagata (JP)

(21) Appl. No.: 15/034,994

(22) PCT Filed: Nov. 8, 2013
(86) PCT No.: PCT/JP2013/080287

§ 371 Date: May 6, 2016

(51) Int. Cl. G06F 3/038; B60R 7/04; G06F 3/041; G06F 3/0354; G06F 3/01; B60N 3/10; B60R 1/00

(52) U.S. Cl. CPC G06F 3/038; B60N 3/102; B60R 7/04; B60R 1/00; G06F 3/03547; G06F 3/017; G06F 3/0414

(57) ABSTRACT

A movable device has a moving portion causing a movable object to move when a motion of a detected object is detected. A shutter of a cup holder is slidably provided in a front and rear direction of a vehicle. A moving unit causes the shutter to move. A detecting sensor is provided on a surface of the shutter. When a person traces the surface of the shutter with a human finger, the detecting sensor detects the human finger at a plurality of positions. At this time, a CPU detects a motion of the human finger and controls the moving unit, and when the human finger moves to a rear side, the moving unit causes the shutter to be slid to the rear side and when the human finger moves to a front side, the moving unit causes the shutter to be slid to the front side.

### TECHNICAL FIELD

The present invention relates to a movable device.

### BACKGROUND ART

As the above-described movable device, a device has been known which opens and closes a shutter (movable object) covering an opening of a cup holder provided in a console box of an automobile (Patent Literature 1). In the cup holder, when a main switch is tilted to an “ON” side, the shutter is automatically opened, and when the main switch is tilted to an “OFF” side, the shutter is automatically closed.

### CITATION LIST

### Patent Literature

### Patent Literature 1: JP 2006-282094 A

### SUMMARY OF INVENTION

### Technical Problem

However, in the above-described cup holder, it is necessary that a user performs an operation to pinch the main switch and tilt the switch to the “ON” side or the “OFF” side. For this reason, the operation of the small main switch during driving of the automobile is bothersome for the user, and a safety problem is mentioned as an example.

In this regard, it is considered that when a finger contacts a surface of the shutter and applies a force in an opening direction, the shutter is opened and conversely, when a finger applies the force in a closing direction, the shutter is closed. Such an operation is, so to speak, similar to a “swiping” on a touch panel, and a relation between an opening/closing of the shutter and an opening/closing operation is easily understood in a human sense compared to the above-described tilting operation of the main switch to the “ON” side or the “OFF” side.

As a configuration in which the opening/closing of the shutter is achieved through the swiping operation, it is firstly considered that a switch for “ON” and a switch for “OFF” are individually provided on a back side of the shutter. Then, when the finger contacts a front side of the shutter and applies a force in the opening direction, the switch for “ON” is pressed, and when the finger contacts the surface of the shutter and applies a force in the closing direction, the switch for “OFF” is pressed and the shutter is closed.

However, in the configuration in which the switches for “ON” and “OFF” are pressed by a light touch such as the swiping operation, there is a risk that when an acceleration is applied to the automobile due to an oscillation in driving the automobile, a startup operation, or a brake operation, an inertia force applied to the shutter presses any one of the switches for “ON” and “OFF” so that an erroneous operation may occur, which can be an example of problems.

It is an object of the invention to overcome the above-described problems. That is, the object of the invention is to provide a movable device in which the erroneous operation can be avoided and which can cause a movable object to move through a simple operation, for example.

### Solution to Problem

In order to achieve the object, a movable device according to a first aspect includes: a movable object which moves in a predetermined direction; a moving portion which causes the movable object to move; and a detecting portion which detects a detected object at a plurality of positions to detect a motion of the detected object, wherein when the detecting portion detects the motion of the detected object, the moving portion causes the movable object to move.

### BRIEF DESCRIPTION OF DRAWINGS

FIG. 1 is a perspective view of a console box in which a movable device according to a first embodiment of the invention is embedded.

FIG. 2 is a partial perspective view schematically illustrating a state where a shutter is detached from the console box in FIG. 1.

FIG. 3 is a perspective view specifically illustrating a moving unit illustrated in FIG. 2.

FIG. 4 is a diagram illustrating an electronic configuration of the console box illustrated in FIG. 1.

FIG. 5 is a flowchart illustrating process procedures of a CPU illustrated in FIG. 4.

FIG. 6 is a perspective view of a console box in which a movable device according to a second embodiment of the invention is embedded.

FIG. 7 is a diagram illustrating a movable device according to another embodiment.

FIG. 8 is a diagram illustrating a movable device according to another embodiment.

FIG. 9 is a diagram illustrating a movable device according to another embodiment.

FIG. 10 is a diagram illustrating a movable device according to another embodiment.

### DESCRIPTION OF EMBODIMENTS

Hereinafter, a movable device according to an embodiment of the invention will be described. The movable device according to an embodiment of the invention includes: a movable object which moves in a predetermined direction; a moving portion which causes the movable object to move; and a detecting portion which detects a detected object at a plurality of positions to detect a motion of the detected object, wherein when the detecting portion detects the motion of the detected object, the moving portion causes the movable object to move.

Accordingly, since the motion of the detected object is detected through the detection of the detected object at the plurality of positions, it is possible to avoid an erroneous operation. The movable object can be caused to move through only the simple operation, that is, the motion of the detected object.

In addition, the detecting portion may detect the detected object at the plurality of positions at different times to detect the motion of the detected object. Accordingly, it is possible to avoid the erroneous operation more reliably.

In addition, the detected object may be a human finger. Accordingly, the movable object can be caused to move through only the simple operation, that is, the motion of the finger.

In addition, a motion of the human finger may be a swiping motion or a flicking motion to trace the movable object with the human finger. Accordingly, the movable object can be caused to move through only the simple operation, that is, the flicking motion or the swiping motion of the finger.

In addition, the detecting portion may detect a motion direction of the human finger in the swiping motion or the flicking motion, and the moving portion may cause the movable object to move in substantially the same direction as the motion direction of the human finger detected by the detecting portion. Accordingly, a corresponding relation between the movement direction of the movable object and the motion direction of the finger is easy to perceive in the human sense.

In addition, the movable object may include a pair of movable units which are provided to contactable with and separable from each other, and a motion of the human finger may be a pinch-in motion or a pinch-out motion to pinch the movable object with two human fingers. Accordingly, the movable object can be caused to move through only the simple operation, that is, the pinch-in motion and the pinch-out motion of the two fingers.

In addition, when the detecting portion detects the pinch-in motion, the moving portion may cause the pair of movable units to move in a direction close to each other, and when the pinch-out motion is detected, the moving portion may cause the pair of movable units to move in a direction apart from each other. Accordingly, the corresponding relation between the movement direction of the movable object and the motion direction of the finger is easy to perceive in the human sense.

In addition, the detecting portion may include a detecting sensor which detects the detected object, and the detecting sensor may be installed on a surface of the movable object. Accordingly, the movable object can be caused to move only by tracing the surface of the movable object with the detected object or moving the detected object near the surface of the movable object.

In addition, the detecting sensor may include a touch panel. In addition, the detecting sensor may include a plurality of pressure sensors and may include a plurality of non-contact sensors.

In addition, the detected object may be a human finger, and an induction member which induces the human finger to the detecting sensor may be provided on the surface of the movable object. Accordingly, even in a state where a user cannot visually perceive the detecting sensor, the user can simply perceive a position of the detecting sensor.

In addition, the movable object may be a container lid. In addition, the movable object may be a glass or a mirror. In addition, the movable object may be a shutter of a cup holder.

In addition, the cup holder may be provided with a sensor which determines whether a cup is present. Then, when the sensor determines that the cup is present in the cup holder, an opening state of the shutter may be maintained. Accordingly, when the cup is present in the cup holder, the shutter does not close.

### EMBODIMENT

### First Embodiment

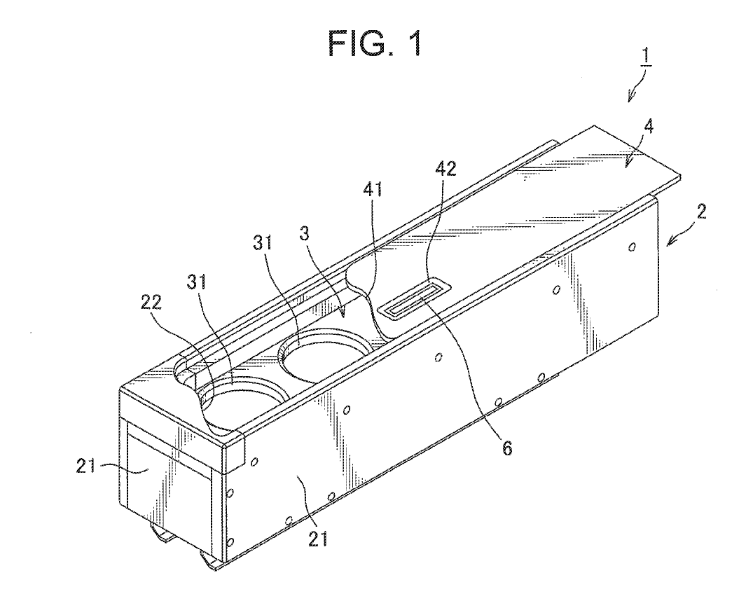

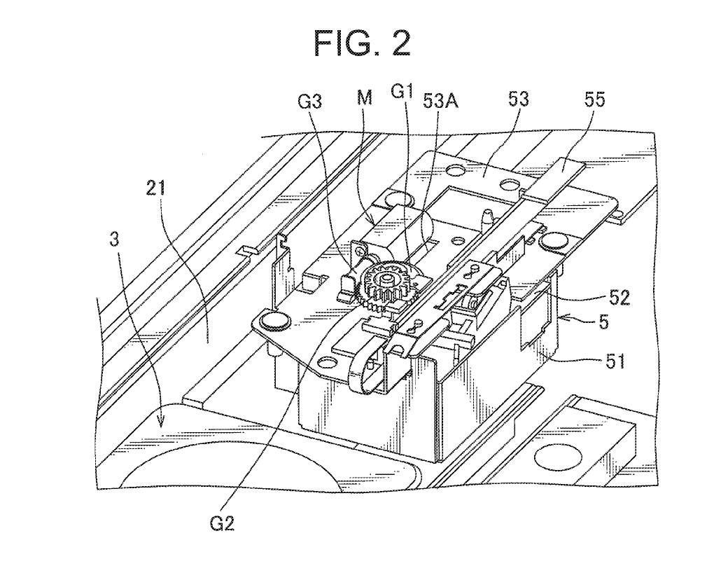

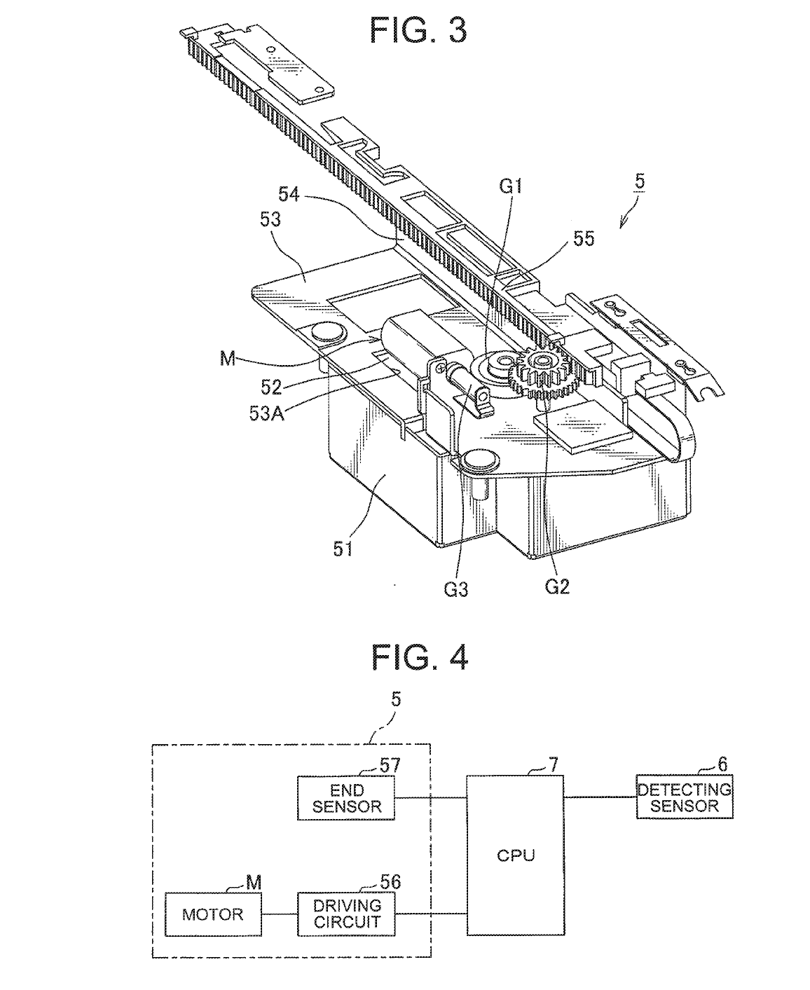

Hereinafter, a movable device of the invention will be described on the basis of FIGS. 1 to 4. FIG. 1 is a perspective view of a console box in which a movable device according to a first embodiment of the invention is embedded. FIG. 2 is a partial perspective view schematically illustrating a state where a shutter is detached from the console box in FIG. 1. FIG. 3 is a perspective view specifically illustrating a moving unit illustrated in FIG. 2. FIG. 4 is a diagram illustrating an electronic configuration of the console box illustrated in FIG. 1. A console box 1 illustrated in those drawings is positioned, for example, on a floor between a driver seat and a front passenger seat of an automobile.

As illustrated in FIG. 1 and the like, the console box 1 includes a box body 2, a cup holder 3 contained in the box body 2, a shutter 4 provided to be slidable (movable) with respect to the box body 2 in a front and rear direction of a vehicle (in a predetermined direction), a moving unit 5 which causes the shutter 4 to move (FIGS. 2 and 3), a detecting sensor 6 which detects a human finger (FIGS. 1 and 4), and a CPU 7 which detects a motion of the human finger from a detection result of the detecting sensor 6 to control the moving unit 5 according to the motion of the human finger (FIG. 4). That is, a moving portion is configured by the moving unit 5 and a function of the CPU 7. In addition, a detecting portion is configured by the detecting sensor 6 and a function of the CPU 7.

As illustrated in FIG. 1, the box body 2 includes a bottom wall (not illustrated) which is long in the front and rear direction of the vehicle and a side wall 21 erected from the bottom wall, and is provided in a box shape having an open top-surface. The cup holder 3 is contained in the box body 2 on a front side in a front and rear direction thereof, two holder concave parts 31 are provided along the front and rear direction. Cups can be held in the holder concave parts 31.

As illustrated in FIG. 1, when the shutter 4 is slid to a rear side in the front and rear direction, an opening of the box body 2 opens to expose the cup holder 3, and when the shutter is slid to a front side in the front and rear direction, the opening of the box body 2 closes to hide the cup holder 3.

As illustrated in FIG. 2, the moving unit 5 is attached on the side wall 21 of the box body 2 on a rear side from the cup holder 3. As illustrated in FIG. 3, the moving unit 5 includes a containing case 51, a substrate 52 contained in the containing case 51, a base plate 53 stacked on the substrate 52, a motor M loaded on the substrate 52, a first gear G1, a second gear G2, and a rail 54 which are loaded on the base plate 53, and a rack 55 slidably attached on the rail 54.

The containing case 51 is provided in the box shape having an open top. A driving circuit 56 of the motor M, an end sensor 57, or the like is loaded on the substrate 52 as illustrated in FIG. 4 to be described below. The base plate 53 is provided to cover an opening of the containing case 51 and is stacked on the substrate 52. The motor M protrudes from an opening 53A provided in the base plate 53 upward compared to the base plate 53, and an output gear G3 of the motor is provided to be engaged with the first gear G1 to be described below. Incidentally, the output gear G3 rotates around an axis along the front and rear direction.

The first gear G1 and the second gear G2 are provided to be engaged with each other and each gear rotates around an axis along a vertical direction. The rail 54 protrudes from a top surface of the base plate 53, and is provided in a long shape along the front and rear direction. The rack 55 is provided along the front and rear direction, and is engaged with the second gear G2. The rack 55 is fixed to the shutter 4. Through the above configuration, when the motor M rotates to cause the output gear G3 to rotate, the rotation force is transmitted to the rack 55 via the first gear G1 and the second gear G2, and the rack 55 moves along the rail 54 in the front and rear direction, whereby the shutter 4 fixed to the rack 55 is also slid in the front and rear direction.

In addition, the moving unit 5 includes the driving circuit 56 loaded on the substrate 52 and the end sensor 57 as illustrated in FIG. 4. The driving circuit 56 is controlled by the CPU 7 and supplies a driving current for driving the motor M as illustrated in FIG. 4. The end sensor 57 detects whether the shutter 4 is positioned at a front end or a rear end in the front and rear direction, and includes a well-known position sensor such as an infrared sensor or a mechanical switch. Incidentally, the moving unit 5 illustrated in FIGS. 2 and 3 is an example, and may have another well-known configuration.

The detecting sensor 6 is installed on a top surface (surface) of the shutter 4. Specifically, the shutter 4 has a hollow shape and contains a substrate (not illustrated) therein, and the detecting sensor 6 is loaded on the substrate. Then, the detecting sensor 6 is exposed from an opening provided on the top surface of the shutter 4.

In addition, the detecting sensor 6 is provided at a corner of a front end of the shutter 4 (a corner closer to the front passenger seat in the example illustrated in FIG. 1). Then, a front end surface 41 of the shutter 4 is provided to be an inclined curve surface in which the front end surface is closer to the front side in the front and rear direction as it goes to the front passenger seat. Further, a facing surface 22, which faces the front end surface 41 of the shutter 4 when the shutter 4 of the box body 2 is closed, is also provided to be the inclined curve surface in which the facing surface is closer to the front side in the front and rear direction as it goes to the front passenger seat. When the front end surface 41 of the shutter 4 and the facing surface 22 of the box body 2 are provided to be substantially inclined as above, the positions of the front end surface 41 and the facing surface 22 can be simply perceived through only the contact of the finger, and when the finger is moved toward the front passenger seat on the front end surface 41 and the facing surface 22, the finger can be induced to the detecting sensor 6. As is clear from the above, the front end surface 41 of the shutter 4 corresponds to an induction member.

Incidentally, in this embodiment, the front end surface 41 and the facing surface 22 are provided to be the inclined curve surface in which the surfaces are closer to the front side in the front and rear direction as it goes to the front passenger seat, but the invention is not limited thereto and may be an inclined curve surface in which the surfaces are closer to the rear side in the front and rear direction as it goes to the front passenger seat. Instead of the above-described inclined curve surface, the front end surface 41 of the shutter 4 may be an inclined surface in which the surfaces are monotonically closer to the front side in the front and rear direction as it goes to the front passenger seat. In addition, the detecting sensor 6 is provided at a corner closer to the front passenger seat in the front end of the shutter 4, but the invention is not limited thereto and may be provided at a corner closer to the driver seat. In addition, the detecting sensor 6 may be provided at a center in a right and left direction. In this case, the front end surface 41 and the facing surface 22 may be provided to be closer to the front side as it goes to the center in the right and left direction. Further, the detecting sensor 6 may be provided at a rear end of the shutter 4, and in this case, a rear end surface of the shutter 4 is provided to be the above-described inclined curve surface.

In addition, on an edge of the opening of the shutter 4 in which the detecting sensor 6 is exposed, a frame part 42 surrounding the edge is provided. Since the frame part 42 protrudes from the top surface of the shutter 4, a position of the detecting sensor 6 is perceived through only the tracing with the human finger. As is clear from the above, the frame part 42 corresponds to an induction member which induces the human finger to the detecting sensor 6. In addition a plurality of the detecting sensors 6 are arranged along the front and rear direction, and are considered to include, for example, a well-known touch panel or a plurality of pressure sensors arranged in the front and rear direction.

When a swiping motion or a flicking motion that the user traces the detecting sensor 6 along the front and rear direction with the finger is detected on the basis of the detection result of the detecting sensor 6, the above-described CPU 7 controls the driving circuit 56 to drive the motor M, and opens and closes the shutter 4. Incidentally, the swiping motion indicates an operation that the user slowly traces the surface of the detecting sensor 6 with the finger and the flicking operation indicates an operation that the user quickly traces the surface of the detecting sensor 6 with the finger as if flicking the surface.

On the basis of the detection result of the detecting sensor 6, the CPU 7 detects a direction in which the human finger moves in the swiping motion or the flicking motion and causes the shutter 4 to move in substantially the same direction as that in which the human finger moves. In this embodiment, when the detected motion direction of the human finger is the rear direction, the CPU 7 causes the shutter 4 to move in the rear direction and opens the shutter 4. Meanwhile, when the detected motion direction of the human finger is the front direction, the shutter 4 is caused to move in the front direction and closes the shutter 4.

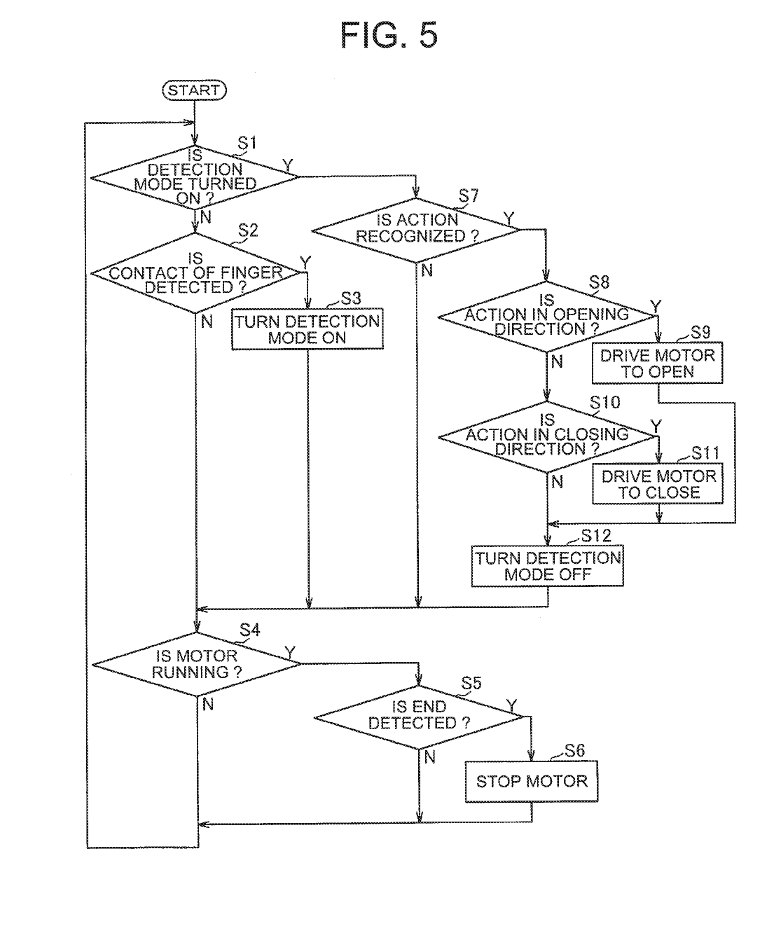

Next, an operation of the console box 1 which is schematically described above will be described with reference to FIG. 5. FIG. 5 is a flowchart illustrating process procedures of the CPU illustrated in FIG. 4. The CPU 7 starts to run, for example, according to an ignition-on of the automobile. First, the CPU 7 determines whether the finger contacts the detecting sensor 6 to turn a detection mode on (step S1). If the detection mode is not turned on (N in step S1), the CPU 7 determines whether the detecting sensor 6 detects the contact of the finger (step S2).

If the detecting sensor 6 detects the contact of the finger (Y in step S2), the CPU 7 turns the detection mode on (step S3) and proceeds to next step S4. Meanwhile, if the detecting sensor 6 does not detect the contact of the finger (N in step S2), the CPU 7 directly proceeds to step S4. In step S4, the CPU 7 determines whether the motor M is running. If the motor M is running (Y in step S4), the CPU 7 determines whether the end sensor 57 detects that the shutter 4 is positioned at the end (step S5).

If the end is detected (Y in step S5), the CPU 7 stops driving the motor M (step S6), and then returns to step S1. If the end is not detected (N in step S5), the CPU 7 does not stop driving the motor M, and returns to step S1. Meanwhile, if the motor M is not running (N in step S4), the CPU 7 does not check the detection result of the end sensor 57, and directly returns to step S1.

In addition, in step S1, if the detection mode is turned on (Y in step S1), the CPU 7 determines whether an action is recognized (step S7). In this embodiment, the action is the swiping motion or the flicking motion described above. Herein, when the finger is detected at the plurality of positions of the detecting sensor 6 at different times, the CPU 7 determines that the swiping motion or the flicking motion is performed. Accordingly, for example, even if the finger erroneously contacts one position of the detecting sensor 6 to turn the detection mode on, the CPU 7 does not recognize the action (N in step S7), and directly proceeds to step S4.

When step S7 is described in detail, at least two detecting sensors 6 are required in order to recognize the swiping motion or the flicking motion. In the simplest detecting and recognizing method, for example, the detecting sensor 6 includes two first and second pressure sensors, and a case where the first pressure sensor detects the human finger and the second pressure sensor detects the human finger within a predetermined time set in advance can be considered as the swiping motion. In addition, a first time when the first pressure sensor detects the human finger is detected and measured, a second time when the second pressure sensor detects the human finger within a predetermined time set in advance is measured, and then a case where the second time is shorter than the first time can be considered as the flicking motion. If the number of the detecting sensor 6 is further three or more, the swiping motion or the flicking motion can be precisely detected and recognized. Incidentally, if the touch panel is stuck as the detecting sensor 6, a method of performing the detection and recognition with a common smart phone and the like can be adopted without change.

Incidentally, the “swiping motion” indicates an operation that the finger is slid in the predetermined direction in the state of contacting a screen among operations on a multi-touch interface, but in the invention, the motion indicates an operation that the detected object (human finger in the above example) moves to be slid on the detecting portion (pressure sensor in the above example) in the predetermined direction. In addition, the “flicking operation” indicates an operation that the finger moves to lightly flick the screen in the predetermined direction among the operations on the multi-touch interface, but in the invention, the motion indicates an operation that the detected object (human finger in the above example) moves to lightly flick the detecting portion (pressure sensor in the above example) in the predetermined direction.

Returning to the flowchart illustrated in FIG. 5, meanwhile, if the action is recognized (Y in step S7), the CPU 7 determines whether the action is an action in an opening direction (step S8). In this embodiment, when the motion direction of the finger in the swiping motion or the flicking motion is in the rear direction as described above, the CPU 7 determines that the action is the action in the opening direction. Then, if it is determined that the action is the action in the opening direction (Y in step S8), the CPU 7 drives the motor M to open the shutter 4 through a movement of the shutter to the rear side (step S9), then turns the detection mode off (step S12), and proceeds to step S4.

On the other hand, if the action is not the action in the opening direction (N in step S8), the CPU 7 determines whether the action recognized in step S7 is an action in a closing direction (step S10). In this embodiment, when the motion direction of the finger in the swiping motion or the flicking motion is the front direction as described above, the CPU 7 determines the action is the action in the closing direction. Then, if it is determined that the action is the action in the closing direction (step S10), the CPU 7 drives the motor M to close the shutter 4 through a movement of the shutter to the front side (step S11), then turns the detection mode off (step S12), and proceeds to step S4. Meanwhile, if the swiping motion or the flicking motion is detected but the motion direction of the finger cannot be detected (N in step S10), the CPU 7 does not drive the motor M and turns the detection mode off (step S12) and proceeds to step S4.

According to the above-described embodiment, the CPU 7 detects the finger at the plurality of positions on the basis of the detection result of the detecting sensor 6 to detect the motion of the finger, and causes the shutter 4 to move. Accordingly, since the swiping motion or flicking motion of the finger is detected by detecting the finger at the plurality of positions, it is possible to avoid the erroneous operation. The shutter 4 can be caused to move through only the simple operation, that is, the swiping or flicking of the finger.

In addition, according to the above-described embodiment, the CPU 7 detects the finger at the plurality of positions at different times to detect the motion of the finger. Accordingly, since the swiping motion, the flicking motion, or the like can be detected, it is possible to avoid the erroneous operation more reliably.

In addition, since the detected object is the human finger according to the above-described embodiment, the shutter 4 can be caused to move through only the simple operation, that is, the motion of the finger. Further, the motion of the human finger is the swiping motion or the flicking motion to trace the shutter 4 with the human finger. Accordingly, the shutter 4 can be caused to move through only the simple operation, that is, the swiping motion or flicking motion of the finger.

In addition, according to the above-described embodiment, the CPU 7 detects the motion direction of the human finger in the swiping motion or the flicking motion, and can cause the shutter 4 to move in substantially the same direction as the detected motion direction of the human finger. Accordingly, a corresponding relation between the movement direction of the shutter 4 and the motion direction of the finger is easy to perceive in the human sense.

In addition, according to the above-described embodiment, the detecting sensor 6 is installed on the surface of the shutter 4. Accordingly, the shutter 4 can be caused to move only by tracing the surface of the shutter 4 with the finger.

In addition, according to the above-described embodiment, the front end surface 41 or the frame part 42 which induces the human finger to the detecting sensor 6 is provided in the shutter 4. Accordingly, even if a user cannot look at the detecting sensor, the user can simply contact the detecting sensor 6.

Incidentally, although the motion direction of the human finger in the swiping motion or the flicking motion is also detected in the above-described first embodiment, the invention is not limited thereto. It is not necessary to detect the direction, and, for example, when the swiping motion or the flicking motion is detected in a state where the shutter 4 is closed, the shutter 4 may be opened regardless of the direction of the motion, and when the swiping motion or the flicking motion is detected in a state where the shutter 4 is opened, the shutter 4 may be closed regardless of the direction of the motion.

### Second Embodiment

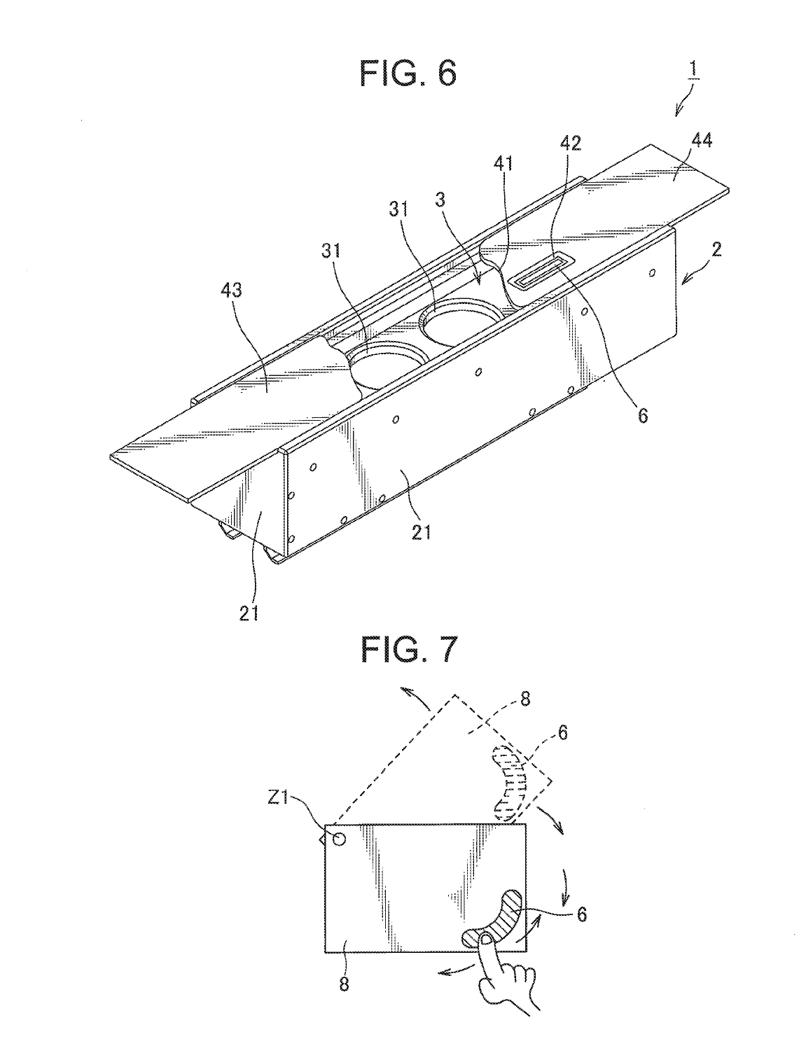

Next, a movable device according to a second embodiment of the invention will be described on the basis of FIG. 6. FIG. 6 is a perspective view of a console box in which the movable device according to a second embodiment of the invention is embedded. In FIG. 6, the same components as in the console box 1 of the first embodiment illustrated in FIGS. 1 to 4 are represented by the same reference numerals and the detailed description thereof is not repeated. The console box 1 includes the box body 2, the cup holder 3, the shutter 4, the moving unit 5, the detecting sensor 6, and the CPU 7 as in the first embodiment. The box body 2 and the cup holder 3 are the same as in the first embodiment, and thus the detailed description thereof is not repeated herein.

The shutter 4 includes a pair of shutters 43 and 44 which are provided to be contactable with and separable from each other. The shutters 43 and 44 are slidable with respect to the box body 2 in the front and rear direction of the vehicle. When the shutters 43 and 44 are slid to move in a direction apart from each other, the opening of the box body 2 opens to expose the cup holder 3 as illustrated in FIG. 6. When the shutters are slid to move in a direction close to each other, the opening of the box body 2 closes to hide the cup holder 3.

The moving unit 5 is provided at each of the shutters 43 and 44, each shutter has the same configuration as in the first embodiment, and thus the detailed description thereof is not repeated herein. The detecting sensor 6 is also the same as in the first embodiment, and thus the detailed description thereof is not repeated herein.

The CPU 7 detects a pinch-in motion that the user pinches the detecting sensor 6 with two fingers or a pinch-out motion on the basis of the detection result of the detecting sensor 6. Incidentally, the pinch-in motion indicates a motion that the user traces the detecting sensor 6 with the two fingers approaching each other, and the pinch-out motion indicates a motion that the user traces the detecting sensor 6 with the two fingers separating from each other.

In addition, when the CPU 7 detects the pinch-in motion, the CPU causes the shutters 43 and 44 to move in the direction close to each other and the shutter 4 is closed. Meanwhile, when the CPU detects the pinch-out motion, the CPU causes the shutters 43 and 44 to move in the direction apart from each other and the shutter 4 is opened.

Next, an operation of the console box 1 which is schematically described above will be described with reference to FIG. 5. Incidentally, since process procedures of the CPU 7 according to the second embodiment is substantially the same as the process procedures of the CPU 7 in the first embodiment illustrated in FIG. 5, only considerably different steps will be described. In step S7, the CPU 7 determines whether an action is recognized, and the action in the second embodiment is the above-described pinch-in motion or pinch-out motion. Herein, when the CPU 7 detects the two fingers at the plurality of positions of the detecting sensor 6 at different times, the CPU determines that the pinch-in motion or the pinch-out motion is performed.

When above-described step S7 is described in detail, at least four detecting sensors 6 are required in order to recognize the pinch-in motion or the pinch-out motion. In the simplest detecting and recognizing method, for example, the detecting sensor 6 includes four first to fourth pressure sensors which are arranged in a row, and a case where both the first and fourth pressure sensors at the both ends of the detecting sensor detect the human finger and both the second and third pressure sensors in the middle of the detecting sensor detect the human finger within a predetermined time set in advance can be considered as the pinch-in motion. Conversely, a case where both the second and third pressure sensors in the middle of the detecting sensor detect the human finger and both the first and fourth pressure sensors at the both ends of the detecting sensor detect the human finger within the predetermined time set in advance can be considered as the pinch-out motion. Incidentally, if the touch panel is stuck as the detecting sensor 6, the method of performing the detection and recognition with the common smart phone and the like can be adopted without change.

Incidentally, the “pinch-in motion” indicates an operation to move two fingers to pinch an operation object in the state of contacting on the screen among the operations on the multi-touch interface, but in the invention, the motion indicates an operation to move two detected objects (human fingers in the above example) to pinch the detecting portion (pressure sensor in the above example). In addition, the “pinch-out motion” indicates an operation to separate two fingers for magnifying the screen among the operations on the multi-touch interface, but in the invention, the motion indicates an operation to spread two detected objects (human fingers in the above example) on the detecting portion (pressure sensor in the above example).

In addition, in step S8, the CPU 7 determines whether the action is the action in the opening direction. In this embodiment, when the pinch-out motion is detected, the CPU 7 determines that the action is the action in the opening direction. Then, if it is determined that the action is the action in the opening direction (Y in step S8), the CPU 7 drives the motor M to open the shutters 43 and 44 by the shutters moving in the direction apart from each other (step S9).

In addition, in step S10, the CPU 7 determines whether the action is the action in the closing direction. In this embodiment, when the pinch-in motion is detected, the CPU 7 determines that the action is the action in the closing direction. Then, if it is determined that the action is the action in the closing direction (Y in step S10), the CPU 7 drives the motor M to close the shutters 43 and 44 by the shutters moving in the direction close to each other (step S11).

According to the above-described second embodiment, when the CPU 7 detects the pinch-in motion, the pair of the shutters 43 and 44 may be caused to move in the direction close to each other, and when the CPU detects the pinch-out motion, the pair of the shutters 43 and 44 may be caused to move in the direction apart from each other. Accordingly, the corresponding relation between the movement direction of the shutter 4 and the motion direction of the finger is easy to perceive in the human sense.

Incidentally, according to the above-described embodiment, if it is determined that the action is the action in the closing direction, the CPU 7 typically closes the shutter 4, but the invention is not limited thereto. For example, the cup holder 3 is provided with a sensor such as a load sensor and the infrared sensor which determines whether a cup is present, and when the CPU 7 determines that the cup is present in the cup holder 3, the CPU may not cause the shutter 4 to close and may maintain an opening state regardless of the detection of the action in the closing direction. Accordingly, when the cup is present in the cup holder 3, the shutter is not closed.

In addition, according to the above-described embodiment, the shutter 4 as the movable object is provided to be slidable, but the invention is not limited thereto. For example, as illustrated in FIG. 7, a movable object 8 such as a container lid may be provided to be rotatable around a center shaft Z1. Incidentally, the center shaft Z1 is along a direction perpendicular to the plate-shaped movable object 8. In this case, the detecting sensor 6 is provided on a surface of the movable object 8 along a rotating direction. Then, the CPU 7 detects the swiping motion or flicking motion of the human finger, and when the human finger moves clockwise, the movable object 8 may be rotated clockwise, and when the human finger moves counterclockwise, the movable object 8 may be rotated clockwise. The container as in FIG. 7 is suitable for a key case in the vehicle, for example.

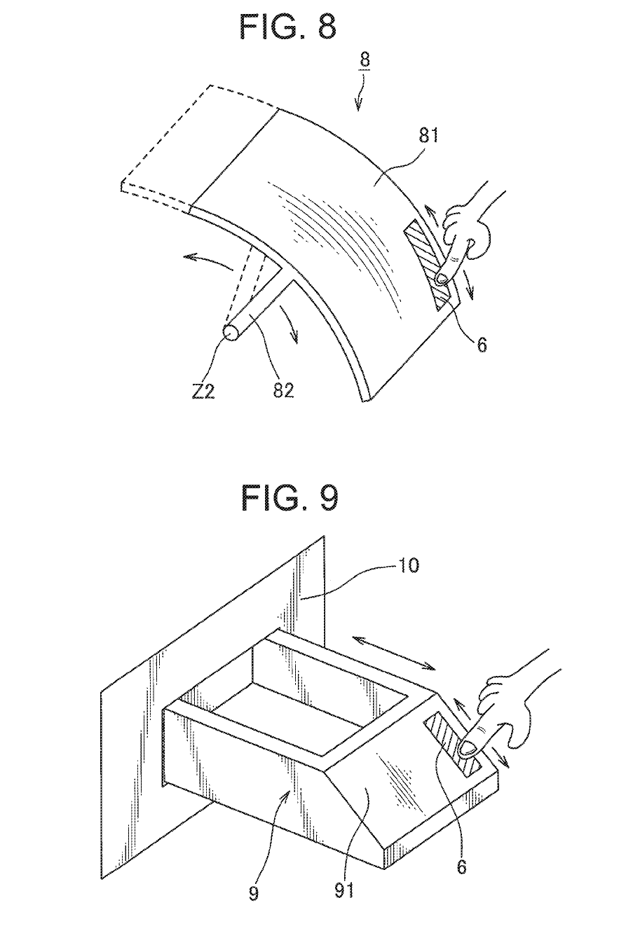

In addition, as illustrated in FIG. 8, the movable object 8 may include a curved plate 81 and a protrusion 82 which protrudes from a back surface of the plate 81 and the movable object 8 may be provided to rotatable around a center shaft Z2 provided at a tip end of the protrusion 82. The container lid, an indicator, particularly, an accessory case provided near the console in the vehicle, and the like are considered as the movable object 8. Incidentally, the center shaft Z1 is a shaft which is along a right and left direction perpendicular to a curved direction of the plate 81. In this case, the detecting sensor 6 is provided to be along the curved direction of a surface of the plate 81. Then, the CPU 7 detects the swiping motion or flicking motion of the human finger, and when the human finger moves clockwise, the CPU may cause the movable object 8 to rotate clockwise, and when the human finger moves counterclockwise, the CPU may cause the movable object 8 to rotate counterclockwise.

In addition, as illustrated in FIG. 9, a drawer 9 which is able to be pulled in and out in a container 10 may be configured as the movable object. In this case, a taper surface 91 is provided on a front surface of the drawer 9, and the detecting sensor 6 is provided on the taper surface 91 along a direction in which the drawer 9 is pulled in and out. Then, the CPU 7 detects the swiping motion or flicking motion of the human finger to detect the motion direction of the human finger. As a result of the detection, when the human finger moves in a pulling-out direction of the pulling-in/out direction, the CPU 7 causes the drawer 9 to move outside the container 10 such that the drawer 9 is pulled out, and when the human finger moves in a pulling-in direction of the pulling-in/out direction, the CPU causes the drawer 9 to move toward the container 10 such that the drawer is contained in the container 10.

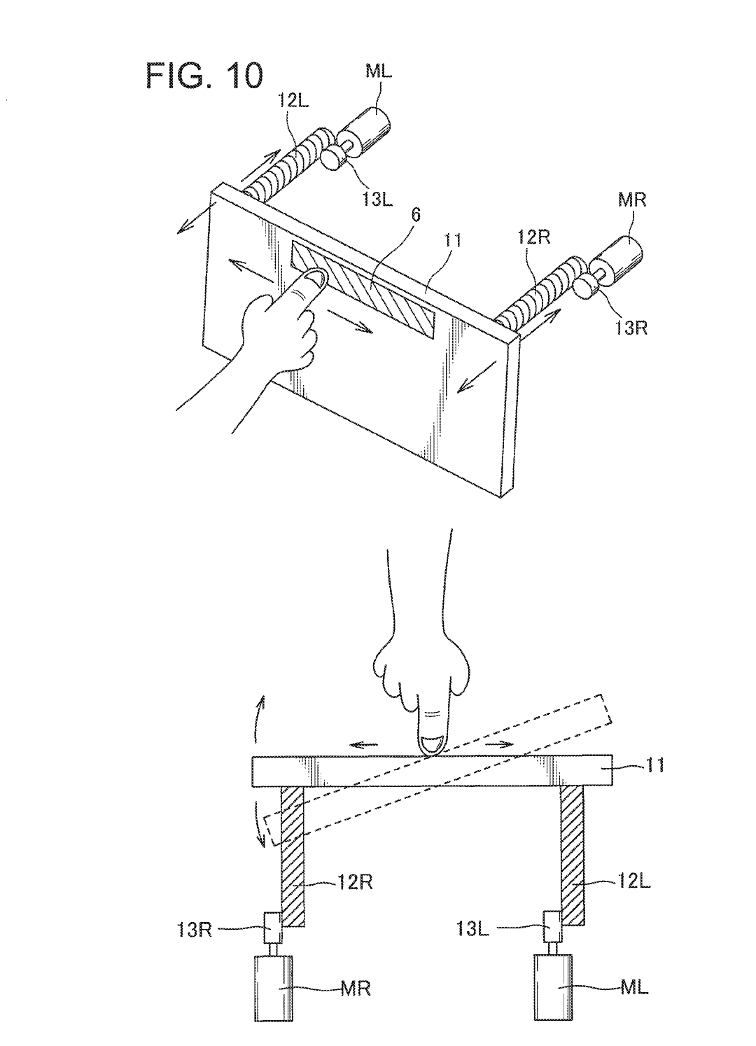

In addition, as illustrated in FIG. 10, the above-described movable object may be a room mirror (mirror) 11. The room mirror 11 is movable such that a right and left inclination thereof can be controlled. As an example of achieving such a configuration, a pair of screws 12R and 12L which are arranged apart from each other in a right and left direction are attached on a back surface of the room mirror 11. Then, the screws 12R and 12L are screwed to output screws 13R and 13L of motors MR and ML, respectively.

Accordingly, when a screw position between the output screw 13L of the motor ML and the left screw 12L is closer to the room mirror 11 and a screw position between the output screw 13R of the motor MR and the right screw 12R is apart from the room mirror 11, the room mirror 11 is inclined such that a left side thereof is in a front position compared to a right side thereof. Conversely, when the screw position between the output screw 13L of the motor ML and the left screw 12L is apart from the room mirror 11 and the screw position between the output screw 13R of the motor MR and the right screw 12R is closer to the room mirror 11, the room mirror 11 is inclined such that the right side thereof is in the front position compared to the left side thereof.

In this case, the detecting sensor 6 is provided on a front surface of the room mirror 11 along the right and left direction. Then, the CPU 7 detects the swiping motion or flicking motion of the human finger, and when the human finger moves in the left direction, the CPU may cause the room mirror 11 to move such that the right side of the room mirror 11 is in the front position compared to the left side thereof, and when the human finger moves in the right direction, the CPU may cause the room mirror 11 to move such that the left side thereof is in the front position compared to the right side thereof.

In addition, an example of the movable object may be a side glass (glass) of the automobile.

In addition, according to the above-described embodiment, a sensor, which detects the contact of the finger, such as the pressure sensor or the touch panel is used as the detecting sensor 6, but the invention is not limited thereto. For example, the detecting sensor 6 may be a non-contact sensor, which can detect the motion of the finger near the sensor without contacting, such as the infrared sensor.

In addition, according to the above-described embodiment, the detected object is the human finger but the invention is not limited thereto. For example, a touch pen may be used as the detected object depending on the movable object.

In addition, the above-described embodiments are merely representative embodiments and the invention is not limited to the embodiments. That is, various changes can be made and practiced without departing the scope of the invention.

### REFERENCE SIGNS LIST

3 cup holder
4 shutter (movable object)
5 moving unit (moving portion)
6 detecting sensor (detecting portion)
7 CPU (detecting portion, moving portion)
8 movable object
9 drawer (movable object)
11 room mirror (movable object)
41 front end surface (induction member)
42 frame part (induction member)
43, 44 a pair of shutters (movable unit)

1. A movable device comprising:
a movable object which moves in a predetermined direction;
a moving portion which causes the movable object to move; and
a detecting portion for detecting a detected object at a plurality of positions to detect a motion of the detected object, wherein
when the detecting portion detects the motion of the detected object, the moving portion causes the movable object to move.

2. The movable device according to claim 1, wherein
the detecting portion detects the detected object at the plurality of positions at different times to detect the motion of the detected object.

3. The movable device according to claim 2, wherein
the detected object is a human finger.

4. The movable device according to claim 3, wherein
a motion of the human finger is a swiping motion or a flicking motion to trace the movable object with the human finger.

5. The movable device according to claim 4, wherein
the detecting portion detects a motion direction of the human finger in the swiping motion or the flicking motion, and
the moving portion causes the movable object to move in substantially the same direction as the motion direction of the human finger detected by the detecting portion.

6. The movable device according to claim 3, wherein
the movable object includes a pair of movable units contactable with and separable from each other, and
a motion of the human finger is a pinch-in motion or a pinch-out motion to pinch the movable object with two human fingers.

7. The movable device according to claim 6, wherein
when the detecting portion detects the pinch-in motion, the moving portion causes the pair of movable units to move in a direction close to each other, and when the pinch-out motion is detected, the moving portion causes the pair of movable units to move in a direction apart from each other.

8. The movable device according to claim 2, wherein
the detecting portion includes a detecting sensor configured to detect the detected object, and
the detecting sensor is installed on a surface of the movable object.

9. The movable device according to claim 8, wherein
the detecting sensor includes a touch panel.

10. The movable device according to claim 8, wherein
the detecting sensor includes a plurality of pressure sensors.

11. The movable device according to claim 8, wherein
the detecting sensor includes a plurality of non-contact sensors.

12. The movable device according to claim 8, wherein
the detected object is a human finger, and
an induction member for inducing the human finger to the detecting sensor is provided on the surface of the movable object.

13. The movable device according to claim 2, wherein
the movable object is a container lid.

14. The movable device according to claim 2, wherein
the movable object is a glass or a mirror.

15. The movable device according to claim 2, wherein
the movable object is a shutter of a cup holder.

16. The movable device according to claim 15, wherein
the cup holder is provided with a sensor determining whether a cup is present.

17. The movable device according to claim 16, wherein
when the sensor determines that the cup is present in the cup holder, the shutter causes an opening state to be maintained.
